(19) United States
(12) Patent Application Publication
(10) Pub. No.: US 2005/0078627 A1
(43) Pub. Date: Apr. 14, 2005

(54) Call setup method for providing push-to-talk service in a cellular mobile telecommunication system

(75) Inventors: Seong-Il Yoon, Seongnam-si (KR); Tae-Won Kim, Yongin-si (KR); Dong-Keon Kong, Suwon-si (KR); Jong-Bum Pyo, Yongin-si (KR); Dae-Gyun Kim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: SAMSUNG ELECTRONICS CO., LTD.

(21) Appl. No.: 10/961,061

(22) Filed: Oct. 12, 2004

(30) Foreign Application Priority Data
Oct. 11, 2003 (KR) 2003-70882

(51) Int. Cl. H04Q 7/00; H04L 12/66

(52) U.S. Cl. 370/328; 370/338; 370/352

(57) ABSTRACT

Disclosed is a method for setting up a call of a push to talk (PTT) service in an access network of a cellular mobile telecommunication system in a system comprising a user agent (UA) capable of performing packet data communication, a cellular mobile telecommunication system capable of providing the UA with a packet data service, and a PTT server connected to the cellular mobile telecommunication system and capable of providing a PTT service with packet data. The method comprises the steps of creating a short data burst (SDB)-type PTT request message as a data burst record when the UA is paged and configuring a data base message (DBM) in such a manner that it includes the created SDB, inserting it into a general page message (GPM), and transmitting it via a predetermined forward channel.

### PRIORITY

This application claims the benefit under 35 U.S.C. 119(a) of an application entitled “Call Setup Method for Push-to-Talk Service in Cellular Mobile Telecommunication System ”filed with the Korean Intellectual Property Office on Oct. 11, 2003 and assigned Serial No. 2003-70882, the entire contents of which are incorporated herein by reference.

### BACKGROUND OF THE INVENTION

1.Field of the Invention

The present invention relates to a call setup method for providing a push-to-talk service in a cellular mobile telecommunication system. More particularly, the present invention relates to a method for reducing the access time of a user agent (UA) to request a push-to-talk service via a reverse radio link.

2.Description of the Related Art

Conventional mobile telecommunication systems may be classified based on usage into a system supporting a voice service and a system supporting a data service. A typical example of a mobile communication system is a code division multiple access (hereinafter, referred to as CDMA) mode system. Conventional CDMA systems which support only a voice service follow international standard (IS)-95 and specifications based on it. Mobile telecommunication systems are now evolving to also support a high speed data service in line with developing telecommunication technology.

As users' demands diversify in line with developing mobile telecommunication systems, user agents (hereinafter, referred to as UAs) including cellular phones and personal communication systems (PCSs) are now providing various services including multimedia information transmission, broadcasting service reception, voice over Internet protocol (hereinafter, referred to as VoIP), and push-to-talk (hereinafter, referred to as PTT) in addition to simply performing one-to-one voice communication.

As used herein, a “PTT service ”refers to a service wherein if a user in a log-in state chooses a friend, a group of friends, a normal user, or a group of normal users requesting voice communication with the user, while watching them displayed on a UA, and requests a PTT service, a communication route is set up 1:1 or between groups in a network capable of providing the PTT service, and communication is provided via the communication route which has been set up. Advantageously, the PTT service makes it possible to begin talking by simply pressing a PTT button, which is impossible in the case of conventional telephones, and is economical in that group communication among three or more participants can be realized.

In a PTT service network configured as above, a protocol for a PTT service may be a session initiation protocol (SIP) for signaling transmission or a real time transport protocol (RTP) for real time voice packet transmission. The SIP, which is an end-to-end and server-client signaling protocol, sets up necessary session information before communication begins and removes the proceeding session information when the communication is over.

If there exists a packet call connected to a UA, signaling messages related to the request and response of a PTT service are received/transmitted via a traffic channel. If no packet call connected to a UA exists, the UA sets up a traffic channel for a PTT call and receives/transmits PTT signaling messages via the traffic channel which has been set up. When a PTT call is to be set up in a dormant state, a UA talker must perform a re-activation procedure first.

When PTT-related SIP signaling messages are transmitted via a traffic channel according to a method as mentioned above, there inevitably occurs a delay related to setup request, response, and calling of the traffic channel. The less time it takes to hear a permission tone and begin talking after a PTT button is pressed, the more useful the PTT service becomes.

In order to provide a PTT service in a radio access network, a short data burst (hereinafter, referred to as SDB) technology has been proposed which can transmit and receive a PTT signaling message even in a dormant state.

As known in the art, a SDB refers to a technology to transmit a limited amount of IP packet via a common channel for signaling and control between a UA in a standby state and a radio access network, specifically via a common control channel/access channel in the EV-DO or via a paging/access channel in the 1X. Such a SDB message service is advantageous in that it is possible to receive/transmit data without any burden caused by traffic channel allocation and the service is therefore supported by most cellular mobile telecommunication systems including CDMA systems. A PTT signaling message, e.g., a request or response message, is transmitted while being loaded into forward and reverse common channels. The PTT signaling message is in a SDB format and is transmitted via a forward common control channel (hereinafter, referred to as F-CCCH) and a reverse extended access channel (hereinafter, referred to as R-EACH). For faster transmission, a PTT UA loads a PTT request message into a data burst message (DBM) and transmits it via a common channel instead of a traffic channel. While waiting for a response to the PTT request message, the PTT UA transmits an origination message or a reconnect message in advance and sets up a traffic channel to transmit PTT voice packets.

A procedure for performing PTT-related SIP message signaling in a dormant state when a UA talker connects a PTT call to a UA listener via a CDMA2000 1X system or a first evolution-data only (1x EV-DO) system supporting a PTT service will now be described with reference to FIG. 1.

A UA talker responds to a user's PTT button pressing and checks whether a traffic channel is currently connected or not. If the traffic channel is not connected (i.e. in a dormant state), the UA talker transmits a SDB-type PTT request message (“INVITE”) to a first access network via an R-EACH in step 110. The UA talker performs a traffic channel setup procedure with the first access network connected thereto in step 120. The first access network transmits the SDB-type PTT request message (“INVITE”) to a PTT server in step 130. The PTT server transmits the SDB-type PTT request message (“INVITE”) to a second access network of a UA listener in step 140. The second access network then transmits the SDB-type PTT request message (“INVITE”) to a single UA listener or a number of US listeners via an F-CCCH in step 150. For convenience of description, it is assumed that the PTT request message is transmitted to a number of UA listeners.

The UA listeners respond to the PTT request message (“INVITE”) and perform a re-actualization procedure with a corresponding radio access network in step 160.

The UA listeners transmit a response to the PTT request message. The UA listeners transmit an origination message or a reconnect message in the same manner as the UA talker and set up a traffic channel to transmit PTT voice packets.

The UA listeners transmit a PTT confirmation message (“200 OK”) to the second access network corresponding to the UA listeners via the R-EACH in step 170. The second access network transmits the PTT confirmation message (“200 OK”) to the PTT server in step 180. The PTT server transmits the PTT confirmation message (“200 OK”) to the first access network in step 190. The first access network transmits the PTT confirmation message to the UA talker or transmits a DBM via a dedicated forward signaling channel in step 200.

The re-actualization in step 160 of FIG. 1 refers to a state wherein the UA listeners in a dormant state reconnect radio channels with the corresponding radio access network. It is assumed that in the scenario of FIG. 1 the UA talker and the UA listeners are in a dormant state in which they store connection information necessary for traffic channel allocation and network connection, respectively. In the dormant state, the radio traffic channel is released in a section having no burst traffic of a data service and the UAs and the radio access network store only information related to reconnection.

Among the information related to reconnection, information related to reverse access which a UA needs to connect to the system may be updated by the system. The UA talker receives an overhead message, e.g., an access parameter message (hereinafter, referred to as APM) or an extended APM (hereinafter, referred to as EAPM), and undergoes an overhead update substate for updating overhead information related to reconnection.

If a UA needs to undergo the overhead update substate for every access, however, it takes longer for a PTT UA to finally set up traffic for PTT communication. Accordingly, it is desirable to reduce the delay caused by the overhead update substate in a CDMA2000 1X system or an EV-DO system.

### SUMMARY OF THE INVENTION

Accordingly, the present invention has been made to solve the above-mentioned problems occurring in the prior art, and an object of the present invention is to provide a method for reducing the system connection time of a user agent (UA) in a dormant state in a cellular mobile telecommunication system.

Another object of the present invention is to provide a method for avoiding a delay of system access time of a UA due to an overhead update substate in a cellular mobile telecommunication system.

Another object of the present invention is to provide a signaling method for a fast call setup for a push to talk (PTT) communication service in a cellular mobile telecommunication system.

Another object of the present invention is to provide a method for reducing a delay time caused by the overhead update substate of a PTT UA for a PTT communication service in a cellular mobile telecommunication system.

In order to accomplish this object, there is provided a method for setting up a call of a PTT service in an access network of a cellular mobile telecommunication system in a system comprising a UA capable of performing packet data communication, a cellular mobile telecommunication system capable of providing the UA with a packet data service, and a PTT server connected to the cellular mobile telecommunication system and capable of providing a PTT service with packet data. The method comprises the steps of creating a short data burst (SDB)-type PTT request message as a data burst record when paging is requested to the UA and configuring a data burst message (DBM) in such a manner that it includes the created SDB, inserting it into a general page message (GPM), and transmitting it via a predetermined forward channel.

In accordance with another aspect of the present invention, there is provided a method for setting up a call of a PTT service in an access network of a cellular mobile telecommunication system in a system comprising a UA capable of performing packet data communication, a cellular mobile telecommunication system capable of providing the UA with a packet data service, and a PTT server connected to the cellular mobile telecommunication system and capable of providing a PTT service with packet data. The method comprises the steps of configuring a DBM including a GPM and a SDB, which are separate messages having different link access controls (LACs), when a paging is requested to the UA and combining the GPM and the DBM and transmitting them via a predetermined forward channel.

In accordance with another aspect of the present invention, there is provided a method for setting up a call of a PTT service in an access network of a cellular mobile telecommunication system in a system comprising a UA capable of performing packet data communication, a cellular mobile telecommunication system capable of providing the UA with a packet data service, and a PTT server connected to the cellular mobile telecommunication system and capable of providing a PTT service with packet data. The method comprising the steps of creating an extended data burst message (EDBM) including overhead update information when paging is requested to the UA and transmitting the created EDBM via a predetermined forward channel.

### BRIEF DESCRIPTION OF THE DRAWINGS

The above and other objects, features and advantages of the present invention will be more apparent from the following detailed description taken in conjunction with the accompanying drawings, in which:

FIG. 1 is a conventional message flowchart showing a call setup method for providing a push to talk (PTT) service in a cellular mobile telecommunication system according to the prior art;

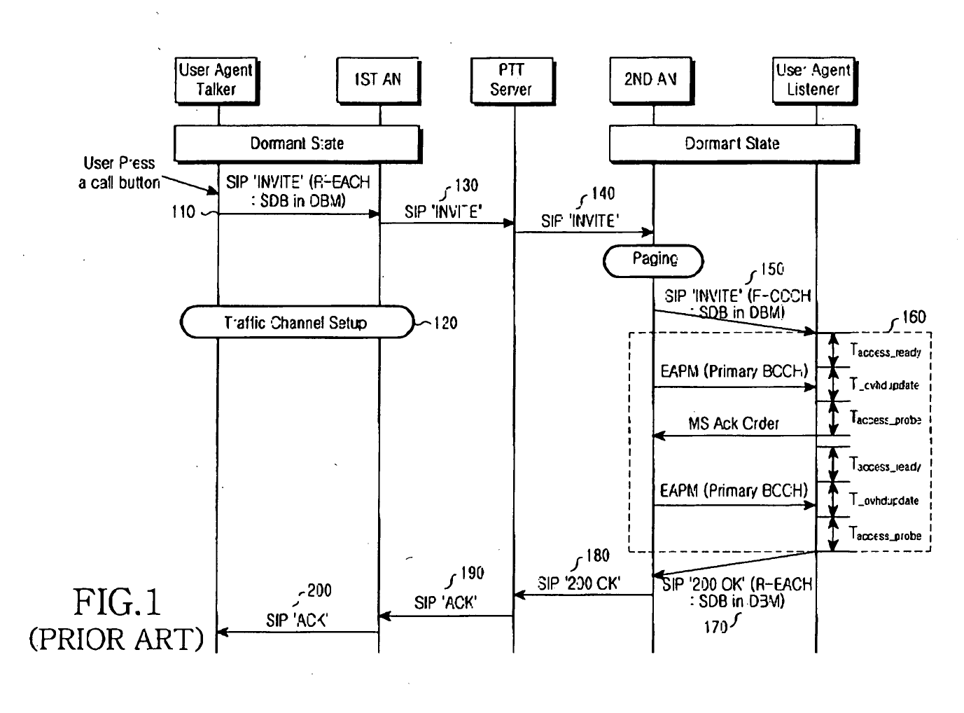

FIG. 2 shows a system configuration for providing a PTT service in a cellular mobile telecommunication system according to an embodiment of the present invention; and

FIG. 3 is a message flowchart showing a call setup method for providing a PTT service in a cellular mobile telecommunication system according to an embodiment of the present invention.

### DETAILED DESCRIPTION OF THE PREFERRED EMBODIMENTS

Hereinafter, embodiments of the present invention will be described with reference to the accompanying drawings. In the following description of the embodiments of the present invention, a detailed description of known functions and configurations incorporated herein will be omitted for conciseness. In addition, the terminology used in the description is defined in consideration of the function of corresponding components used in the embodiments of the present invention and may be varied according to users, operator's intention or practices.

As will be described below, the embodiments of the present invention are directed to quickly setting up a traffic channel for push to talk (PTT) communication, while reducing delay related to call setup, when providing a group call service using a radio network, in particular, a PTT communication service or a voice over Internet Protocol (VoIP). Specifically, the embodiments of the present invention provide a method for enabling a user agent (UA) or mobile terminal listener to omit an overhead update substate by making an initial PTT request message in a short data burst (SDB) type, when a UA talker requests a PTT service on a reverse radio link, and by transmitting overhead update information, such as an access message sequence (acc_msg_seq) and a configuration message sequence (config_msg_seq), to the UA listener concurrently with transmitting a data burst message (DBM) including the SDB.

An operation of an embodiment of the present invention will now be described in detail with reference to a call setup technology for an efficient PTT service in a mobile telecommunication system using code division multiple access 2000 1X (CDMA2000 1X) or first evolution-data only (EV-DO) and radio interface standard based on the same. However, it should be clear to those skilled in the art that the basic objective of the present invention of reducing access time by omitting an overhead update substate can be applied with slight modification to other mobile telecommunication systems having a similar technical background and channel type without departing from the scope of the present invention.

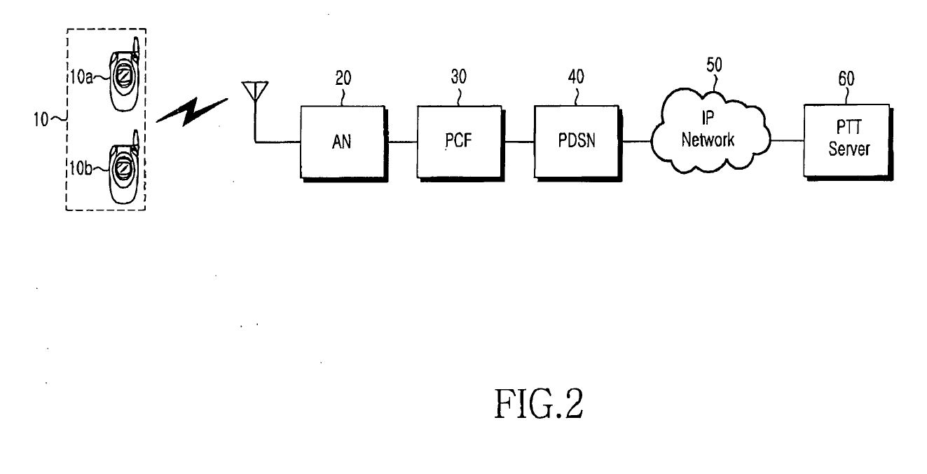

A system configuration for realizing an embodiment of the present invention as mentioned above will now be described with reference to FIG. 2.

FIG. 2 shows a system for providing a PTT service in a CDMA2000 1X system or an EV-DO system. The system comprises a UA 10 which supports a PTT service, has a PTT button mounted thereon, and can perform radio connection according to CDMA2000 1X or EV-DO standard and a radio access network (RAN) or an access network (AN) 20 which transmits/receives packets to/from the UA 10 via a radio channel. The system further comprises a packet control function (hereinafter, referred to as PCF) 30 which connects the radio access network 20 to a packet data service node 40 and controls the dormant state and a packet data service node (PDSN) 40 which connects the PCF 30 to a Internet Protocol (IP) or packet telecommunication network 50 to provide the UA 10 with a packet data service and a packet-type voice service. The system further comprises a PTT server 60 connected to the packet telecommunication network 50 to manage a PTT session and to relay a voice packet from a UA talker to a UA listener group 10b.

A UA 10 of a talker side is referred to as a UA talker 10a and that of a listener side as a UA listener 10b. The term “radio access network” 20 is used in the EV-DO and may be referred to as base station system (BBS) in the 1X.

According to an embodiment of the present invention, when a DBM is transmitted while being included in a general page message, when a general page message and a DBM are transmitted together, and when an extended DBM is transmitted, an application layer L3 of the access network 20 loads a SDB, which has been transmitted via the PCF 30, into a data burst record and transmits it to the UA 10.

The UA 10 transmits the SDB message included in the DBM to a superior packet application program. The UA uses overhead update information transmitted together with the DBM message and can omit the overhead update substate if the overhead update information has not been changed.

The present invention provides three embodiments to transmit the overhead update information together with the DBM:

In a first embodiment, a DBM is transmitted while being included in a general page message (hereinafter, referred to as GPM);

In a second embodiment, a GPM and a DBM are transmitted together; and

In a third embodiment, an extended DBM (hereinafter, referred to as EDBM) including overhead update information, such as the access message sequence and the configuration message sequence, is transmitted.

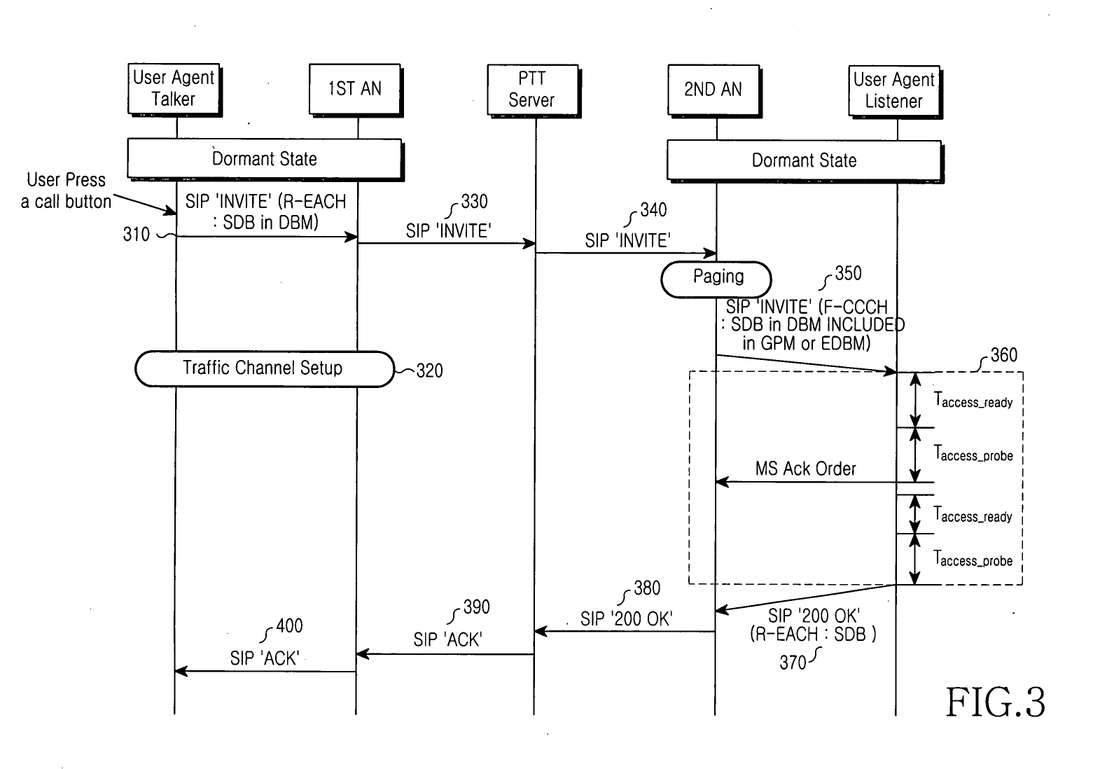

The first embodiment of the present invention in a system having the configuration as shown in FIG. 2 will now be described with reference to FIG. 3. The second and third embodiments will also be described with reference to FIG. 3, but a description of similar configurations and operations will be omitted for conciseness.

In an embodiment of the present invention, a PTT signaling (request/response) message is transmitted while being loaded into forward and reverse common channels. The PTT signaling message is made in an SDB format. The PTT signaling message is transmitted via a forward common control channel (F-CCCH) and a reverse extended access channel (R-EACH). However, the PTT signaling message according to an embodiment of the present invention uses a common channel, in particular, a common control channel/access channel in the EV-DO and may also be transmitted via a paging/access channel in the 1X.

FIG. 3 shows a message flowchart for performing a PTT service via a common channel according to an embodiment of the present invention. Although other network devices including PCFs and PDSNs are not shown in FIG. 3, it should be understood that the message flow among UA talkers or listeners, access networks, and PTT servers go through corresponding PCFs and PDSNs.

The first embodiment will now be described with reference to FIG. 3. A UA talker 10a checks whether a traffic channel is currently connected or not in response to a user's PTT button pressing. If the traffic channel is not connected (i.e. in a dormant state), the UA talker transmits a SDB-type PTT request message (“INVITE”) to a first access network via a R-EACH in step 310. The UA talker 10a performs a traffic channel setup procedure with a corresponding radio access network in step 320. Meanwhile, the first access network transmits the PTT request message (“INVITE”) to a PTT server 60 in step 330. The PTT server 60 then transmits the PTT request message (“INVITE”) to a second access network in which a UA listener is positioned in step 340. The second access network then writes a data burst record using the SDB-type PTT request message (“INVITE”), inserts a DBM including an SDB into a GPM, and transmits it to UA listeners 10b via an F-CCCH in step 350.

An example of the GPM format is given below in Table 1.

TABLE 1

| Field | Length (bits) |
|---|---|
| CONFIG_MSG_SEQ | 6 |
| ACC_MSG_SEQ | 6 |
| CLASS_0_DONE | 1 |
| CLASS_1_DONE | 1 |
| TMSI_DONE | 1 |
| ORDERED_TMSIS | 1 |
| BROADCAST_DONE | 1 |
| RESERVED | 4 |
| ADD_LENGTH | 3 |
| ADD_PFIELD | 8 × ADD_LENGTH |

Referring to Table 1, the GPM includes overhead update information, such as a configuration message sequence (CONFIG_MSG_SEQ) and an access message sequence (ACC_MSG_SEQ). The second access network keeps a record of the SDB on the DBM and transmits the DBM while being included in the added field (ADD_PFIELD) in step 350.

After receiving the GPM, the UA list ener 10b transmits an access message via an R-ACH or R-EACH. Considering the fact that an overhead update substate is omitted, if the overhead update information has not been changed, during transmission via the R-ACH or the R-EACH and that, even when a PTT INVITE/OK message of an SDB is reduced through signal compression, it still has a size of tens of bytes, there is little difference in message size even when included in the GPM, which has the size of a few bytes, compared with conventional transmission of a DBM message.

An example of a DBM recorded as the added field (ADD_PFIELD) of the GPM is given below in Table 2.

TABLE 2

| Field | Length (bits) |
|---|---|
| MSG_SEQ | 3 |
| IMSI_S2 | 10 |
| IMSI_S1 | 24 |
| RESPOND_IND | 2 |
| MSG_NUMBER | 8 |
| BURST_TYPE | 6 |
| NUM_MSGS | 8 |
| NUM_FIELDS | 8 |
| CHARi | 8 × NUM_FIEDLS |

Referring to Table 2, BURST_TYPE field refers to the kind of included data and NUM_FIELDS field refers to the number of fields included in the following CHARi field. When the BURST_TYPE field has a predetermined value which represents a DBM type corresponding to PTT signaling (request/response), the CHARi field includes the content of a PTT request/response message which the UA talker 10a or the UA listener 10b wants to transmit. The DBM further includes RESPOND_IND which determines whether the UA listener 10b is going to transmit a page response to a GPM message, or not, for the following reasons:

When the UA listener 10b in a dormant state receives a GPM transmitted by the second access network to set up a packet incoming call, it transmits a page response to the second access network via the R-ACH or R-EACH regardless of whether data to be transmitted exists or not. When the UA listener 10b receives a PTT INVITE message, a PTT superior application program transmits an OK message to the second access network. If it is confirmed that the UA listener 10b has received the OK message from the second access network, it makes an originating call to request traffic allocation. A method is necessary to determine whether the UA listener 10b , after receiving the PTT INVITE message via the GPM, is supposed to transmit a page response to the GPM or to simply follow a procedure after receiving the PTT INVITE message.

When the DBM is to be transmitted in a record type included in the GPM, therefore, the RESPOND_IND is added to the GPM in order to determine whether the UA must transmit a page response to the GPM or not.

The RESPOND_IND is a two-bit field and the usage thereof according to a setup value for each field is given below in Table 3.

TABLE 3

| RESPOND_{—} | | |
|---|---|---|
| IND: 2 bits | Usage | Peculiarity |
| 00: NO | When a UA does not need to make a page | |
| RESPONSE | response, e.g., in the case of a PTT INVITE | |
| | message | |
| | When no page response is necessary, e.g., in | |
| | the case of a normal PPP frame incoming | |
| 01: | When a system wants to receive a page | Also |
| RESPOND | response to a GPM from a UA | applicable |
| | | to a PTT |
| | | INVITE |
| | | message |
| 10: OTHER | When a response to other access message | |
| RESPONSE | for other DBM needs to be received, except | |
| | for a page response | |
| 11: reserved | | |

The UA listener 10b performs a re-actualization procedure with the corresponding second access network in response to the PTT request message (“INVITE”) in step 360. The UA listener 10b transmits a response to the PTT request message. The UA listener 10b transmits an origination message or a reconnect message in the same manner as the UA talker and sets up a traffic channel to transmit PTT voice packets. The UA listener 10b uses an access message sequence transmitted via the GPM and can omit the overhead update substate. The UA listener 10b refers to the RESPOND_IND included in the DBM message and determines whether to make a page response to the GPM or not.

The UA listener 10b transmit a PTT confirmation message (“200 OK”) of an SDB type to the second access network via the R-EACH in step 370. The second access network then transmits the PTT confirmation message (“200 OK”) to the PTT server 60 in step 380. The PTT server 60 transmits a PTT confirmation message (“Grant/Deny”) to the first access network in step 390. When the second access network transmits the PTT confirmation message (“200 OK”) to the UA talker 10a in step 400, the UA talker 10a rings a permission tone. Voice packets then can be transmitted between the UA talker 10b and the first access network and between the second access network and the UA listener 10b according to RTP.

In the second embodiment, the DBM which is transmitted in step 350 of FIG. 3 is not defined as a paging record of the GPM. Instead, the GPM and the DBM are separately transmitted to the paging or F-CCCH so that the UA listener 10b can simultaneously receive and process the GPM and the DBM. When included in the GPM as a record, there is a single LAC (link access control). In this case, however, the GPM and the DBM are separate messages having different LACs.

When processing an access message related to the DBM in step 360, the UA listener 10b may refer to the ACC_MSG_SEQ/CONFIG_MSG_SEQ of the GPM and omit the overhead update substate. The UA listener 10b does not make a page response to the GPM received as DBM+GPM.

In the third embodiment, the access network redefines and transmits an EDBM in step 350. An example of the EBDM is given below in Table 4.

TABLE 4

| Field | Length (bits) |
|---|---|
| CONFIG_MSG_SEQ | 6 |
| ACC_MSG_SEQ | 6 |
| MSG_NUMBER | 8 |
| BURST_TYPE | 6 |
| NUM_MSGS | 8 |
| NUM_FIELDS | 8 |
| CHARi | 8 × NUM_FIEDLS |

Referring to Table 4, the general DBM message further includes CONFIG_MSG_SEQ and ACC_MSG_SEQ fields.

Accordingly, the UA listener 10b uses the CONFIG_MSG_SEQ and ACC_MSG_SEQ included in the EDBM in step 360 and can omit the overhead update substate. The reason the overhead update substate can be omitted is as follows:

When no information needs to be changed, the radio access network transmits the same overhead message constantly (normally at every 1.28 sec) with the same sequence to the UA 10. The UA 10 keeps the corresponding sequence whenever an overhead message (message transmitting forward/reverse and system-related information) comes in. The UA 10 compares the kept sequence with the sequence of a new message, upon receiving the next overhead message, and checks the content change. If the sequence is identical, the UA 10 may omit the overhead update substate and, if the sequence is different, the UA must undergo the overhead update substate and update the changed content. As such, the UA 10 can check whether the overhead has been updated or not by simply comparing the sequence without reading all fields of the message. By including the sequence into the EDBM, the sequence can be compared without receiving a new overhead message. This makes it possible to reduce the delay time caused by overhead update procedure and to reduce the traffic setup time of the UA 10 for communication.

The UA 10 usually maintains the original slot mode even after receiving the EDBM and the application program of the UA 10 determines whether the UA 10 must make a page response (DBM) to the EDBM or not.

The access time of a PTT service undergoing the overhead information update substate and that of a PTT service omitting the overhead information update substate according to an embodiment of the present invention have been calculated and are given below. For convenience of calculation, the internal processing delay of the radio access network and the PTT server has been ignored.

$$Access time including the overhead information update substate = Order [ Taccess\_ready + Tovhd\_update + Taccess\_probe ] + DBM [ Taccess\_ready + Tovhd\_update + Taccess\_probe ]$$

$$Access time omitting the overhead information update substate = Order [ Taccess\_ready + Taccess\_probe ] + EDBM [ Taccess\_ready + Taccess\_probe ]$$

It is clear from above that the access time has been reduced according to embodiments of the present invention.

Embodiments of the present invention can be applied, for example, to the case of a general PPP frame, in order to omit the overhead update substate, wherein a UA must send a page response after transmitting a DBM to a superior application program, in addition to the case of a DBM which is sent to the UA for a special purpose (e.g., a SDB for PTT incoming).

As mentioned above, overhead update information is transmitted together with a DBM according to an embodiment of the present invention. This makes it possible to omit the overhead information update substate, if it is confirmed that the overhead update information coincides with the existing value kept by the UA, and to reduce access time. As a result, the call setup time of the UA listener is shortened.

While the invention has been shown and described with reference to certain embodiments thereof, it should be understood by those skilled in the art that various changes in form and details may be made therein without departing from the spirit and scope of the invention as defined by the appended claims. For example, although separate messages are defined and used for PTT signaling in the description, it should be understood that the present invention provides an efficient procedure regarding radio conformation and a method for managing radio resources for a PTT service and that other types of signaling may be used in addition to SIP. Accordingly, the scope of the present invention is not limited by the described embodiments, but must be defined by the appended claims and equivalents thereof.

1. A method for setting up a call for a push to talk (PTT) service in an access network of a cellular mobile telecommunication system in a system comprising a user agent (UA) capable of performing packet data communication, a cellular mobile telecommunication system capable of providing the UA with a packet data service, and a PTT server connected to the cellular mobile telecommunication system and capable of providing a PTT service for packet data, the method comprising the steps of:
creating a short data burst (SDB)-type PTT request message as a data burst record when paging is requested from the UA and
configuring a data base message (DBM) in such a manner that it includes the created SDB, inserting it into a general page message (GPM), and transmitting it via a predetermined forward channel.

2. The method as claimed in claim 1, wherein the predetermined forward channel is a forward common control channel (F-CCCH).

3. The method as claimed in claim 1, wherein the GPM includes the overhead update information of a configuration message sequence (CONFIG_MSG_SEQ) and an access message sequence (ACC_MSG_SEQ).

4. The method as claimed in claim 1, wherein the GPM includes a response field (RESPOND_IND) for determining whether to transmit a page response to the access network or not.

5. The method as claimed in claim 4, wherein the page response is transmitted to the access network via a random access channel (R-ACH) or a reverse extended access channel (R-EACH).

6. The method as claimed in claim 1, wherein the DBM is transmitted while being included in the added field (ADD_PFIELD) of the GPM.

7. A method for setting up a call for a push to talk (PTT) service in an access network of a cellular mobile telecommunication system in a system comprising a user agent (UA) capable of performing packet data communication, a cellular mobile telecommunication system capable of providing the UA with a packet data service, and a PTT server connected to the cellular mobile telecommunication system and capable of providing a PTT service for packet data, the method comprising the steps of:
creating a short data burst (SDB)-type PTT request message as a data burst record with the access network when a paging is requested to the UA, configuring a data burst message (DBM) in such a manner that it includes the created SDB, inserting it into a general page message (GPM), and transmitting it via a predetermined forward channel and
determining whether the GPM includes overhead update information with the UA upon receiving the GPM, immediately creating a page response without performing an overhead update substate, when the GPM includes overhead update information and there is no change in information, and transmitting the page response via a predetermined reverse channel.

8. The method as claimed in claim 7, wherein the predetermined forward channel is a forward common control channel (F-CCCH).

9. The method as claimed in claim 7, wherein the GPM includes the overhead update information of a configuration message sequence (CONFIG_MSG_SEQ) and an access message sequence (ACC_MSG_SEQ).

10. The method as claimed in claim 7, wherein the DBM is transmitted while being included in the added field (ADD_PFIELD) of the GPM.

11. The method as claimed in claim 7, wherein the GPM includes a response field (RESPOND_IND) for determining whether to transmit a page response to the access network.

12. The method as claimed in claim 11, wherein the page response is transmitted to the access network via a random access channel (R-ACH) or a reverse extended access channel (R-EACH).

13. A method for setting up a call for a push to talk (PTT) service in an access network of a cellular mobile telecommunication system in a system comprising a user agent (UA) capable of performing packet data communication, a cellular mobile telecommunication system capable of providing the UA with a packet data service, and a PTT server connected to the cellular mobile telecommunication system and capable of providing a PTT service for packet data, the method comprising the steps of:
configuring a data burst message (DBM) including a general page message (GPM) and a short data burst (SDB), which are separate messages having different link access contacts (LACs), when the UA is paged and
combining the GPM and the DBM and transmitting them via a predetermined forward channel.

14. The method as claimed in claim 13, wherein the predetermined forward channel is a forward common control channel (F-CCCH).

15. The method as claimed in claim 13, wherein the page response is transmitted to the access network via a random access channel (R-ACH) or a reverse extended access channel (R-EACH).

16. The method as claimed in claim 13, wherein the GPM includes the overhead update information of a configuration message sequence (CONFIG_MSG_SEQ) and an access message sequence (ACC_MSG_SEQ).

17. A method for setting up a call for a push to talk (PTT) service in an access network of a cellular mobile telecommunication system in a system comprising a user agent (UA) capable of performing packet data communication, a cellular mobile telecommunication system capable of providing the UA with a packet data service, and a PTT server connected to the cellular mobile telecommunication system and capable of providing a PTT service for packet data, the method comprising the steps of:
configuring a data burst message (DBM) including a general page message (GPM) and a short data burst (SDB), which are separate messages having different link access controls (LACs), with the access network when the UA is paged, combining the GPM and the DBM, and transmitting them via a predetermined forward channel and
determining whether the GPM includes overhead update information with the UA upon receiving the GPM and the DBM and omitting an overhead update substate when the overhead update information is included and there is no change in information.

18. The method as claimed in claim 17, wherein the predetermined forward channel is a forward common control channel (F-CCCH).

19. The method as claimed in claim 17, wherein no page response to the GPM is transmitted when the GPM is received in a combined form of the GPM and the DBM.

20. The method as claimed in claim 17, wherein the overhead update information includes a configuration message sequence (CONFIG_MSG_SEQ) and an access message sequence (ACC_MSG_SEQ).

21. A method for setting up a call for a push to talk (PTT) service in an access network of a cellular mobile telecommunication system in a system comprising a user agent (UA) capable of performing packet data communication, a cellular mobile telecommunication system capable of providing the UA with a packet data service, and a PTT server connected to the cellular mobile telecommunication system and capable of providing a PTT service of packet data, the method comprising the steps of:
creating an extended data burst message (EDBM) including overhead update information when a paging is requested to the UA and
transmitting the created EDBM via a predetermined forward channel.

22. The method as claimed in claim 21, wherein the overhead update information includes a configuration message sequence (CONFIG_MSG_SEQ) and an access message sequence (ACC_MSG_SEQ).

23. The method as claimed in claim 22, wherein the predetermined forward channel is a forward common control channel (F-CCCH).

24. A method for setting up a call for a push to talk (PTT) service in an access network of a cellular mobile telecommunication system in a system comprising a user agent (UA) capable of performing packet data communication, a cellular mobile telecommunication system capable of providing the UA with a packet data service, and a PTT server connected to the cellular mobile telecommunication system and capable of providing a PTT service for packet data, the method comprising the steps of:
creating an extended data burst message (EDBM) including overhead update information with the access network when a paging is requested to the user agent (UA) and transmitting the created EDBM via a predetermined forward channel and
determining whether the EDBM includes overhead update information or not with the UA upon receiving the EDBM, creating a page response without performing an overhead update substate when the overhead update information is included and there is no change in information, and transmitting it via a predetermined reverse channel.

25. The method as claimed in claim 24, wherein the overhead update information includes a configuration message sequence (CONFIG_MSG_SEQ) and an access message sequence (ACC_MSG_SEQ).

26. The method as claimed in claim 24, wherein the predetermined forward channel is a forward common control channel (F-CCCH).

27. The method as claimed in claim 24, wherein the predetermined reverse channel is a random access channel (R-ACH) or a reverse extended access channel (R-EACH).
